(19) United States
(12) Patent Application Publication
(10) Pub. No.: US 2012/0053276 A1
(43) Pub. Date: Mar. 1, 2012

(54) SURFACE POLISH AND WEAR COATING

(75) Inventor: James V. Hodson, Fruit Heights, UT (US)

(73) Assignee: Brilliant Coatings, Inc., Niagara Falls, NY (US)

(21) Appl. No.: 12/872,237

(22) Filed: Aug. 31, 2010

(51) Int. Cl. C08K 5/06

(52) U.S. Cl. 524/377

(57) ABSTRACT

The invention relates to a polish including acrylic polymers and a wetting agent comprising a high-weight alcohol mixed with glycol-n-butyl ether.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A “SEQUENCE LISTING”

Not applicable.

### FIELD OF THE INVENTION

Invention relates to protective polish coatings found in the industrial, commercial, and domestic environments.

### BACKGROUND OF THE INVENTION

Aqueous coating compositions are well known and find use as protective coatings for various substrates such as wood, metal, plastic and the like. Such compositions typically contain a film-forming polymer such as an acrylic polymer. That polymer forms a continuous protective coating over the substrate, often in conjunction with other additive materials such as other polymers, resins, pigments, dyes, ultraviolet light absorbing agents and the like, to help protect it from damage caused by the sun, abrasion, foot traffic, pressure, and so forth. The film-forming polymers are typically selected for their physical properties such as water resistance, flexibility, hardness, resilience, toughness, scratch and marking resistant (black heel marks) and the like to fit the needs of the substrate being protected and the environment in which the coating will be used.

Buildings have floors, bathrooms, hallways and kitchens that provide multiple surfaces that are hard and may require polish to make cleaning easier and improve looks. Generally the floor polish materials are different from those materials used on counters and walls. Further, there may be provided different polishes for different surfaces, whereby ceramic surfaces, steel surfaces, and wood surfaces would be treated with different polishes.

There remains a need for a acrylic polish that would give a hard surface on a variety of substrates. Further, there's a need for such polish that will not be slippery when it is walked on.

### SUMMARY OF THE INVENTION

The invention relates to a polish including acrylic polymers and a wetting agent comprising a high-weight alcohol mixed with glycol-n-butyl ether.

### DETAILED DESCRIPTION OF THE INVENTION

The polish of the invention has numerous advantages over prior polishes. The invention polish provides a superior quality gloss and water resistant finish. Surfaces treated with the invention polish do not attract dust particles as will the solvent based cleaners. The polish can be used safely on substantially all surfaces with outstanding results if a high gloss result is desired. The invention polish imparts an environmentally safe coating to a wide range of surface areas. The unique chemical composition provides a safe, non-slippery, coating that does not require the use of conventional anti-slip materials such as fumed silica. This allows for extended use life of the coating. This product does not contain wax and is, therefore, much more resistant to scuffing and abrading. This product will perform four to five times longer than some other conventional multi-surface wear coatings.

The invention provides for a multi-spectrum polishing material that reduces wear and costs of maintenance. The ability of the material to coat most any surface and provide for extended protection that is superior to the state of the art materials is a product that is needed for private, commercial, and industrial purposes. The preferred polymer complex consists of acrylic polymers, vinyl copolymers and high weight propylene glycols diluted with water to provide a low viscosity coating for polishing the many and varied surfaces. Application rates of between 200 and 300 square feet per gallon of the invention polish provides for a low cost maintenance product that is superior to conventional products.

The invention polish generally comprises an acrylic polymer and vinyl copolymer to be used in conjunction with wetting agents, and high molecular weight propylene glycols to provide a surface wear coat to metal, wood, naugahyde, plastics, rubber, ceramics, and vinyl tile. The product provides for a long-lasting surface coating that is skid resistant when exposed to foot traffic in areas such as airport walkways, school hallways and such areas that are of a similar flooring material. This also applies to any area of hard surface such as dashboards found in automobiles, wood panels, and metal surfaces found on appliances.

All buildings have floors, walls, panels, and hard plastic furniture. All buildings require a number of products to provide for protective coatings. The unique aspects of the polish of the invention is that it provides for a multi-spectrum application on the various exposed surface areas. It represents an almost universal polish for all surfaces that require maintenance cleaning and protection.

Floors that have been coated with the invention polish have a polish that lasts over a more extended period of use than floors that have been treated with other polishes. Extended wearability provides for reduced replacement and, therefore, reduced cost of maintenance.

The acrylic polymer utilized in the invention may be any acrylic polymer that provides a suitable finish. Typical of such polymers are vinyl-butyl acrylics. Methyl acrylics are suitable for the invention. The preferred acrylic polymers are a blend of Acrylic Polymer Emulsion—Roplex CS-4000 at a ratio of 80% mixed with a Vinyl Acrylic Copolymer Emulsion—Rovace 661 at a ratio of 20%. The Roplex CS-4000 comprises an all acrylic emulsion. The Rovace 661 is composed of poly butyl acrylic/vinyl acrylic blend.

The vinyl copolymers utilized in the polish of the invention may be any suitable vinyl polymers that provide a suitable polish. Typical of such copolymers are vinyl-butyl acrylic polymers. Suitable vinyl copolymers include poly butyl acetate vinyl acrylic and vinyl acetate acrylic copolymer. A preferred vinyl copolymer is Rovace 661 because it provides a vinyl acrylic with the best emulsion properties.

Any suitable high molecular weight glycol may be utilized in the invention. A suitable material is ethylene glycol. The preferred material is propylene glycol in a weight average molecular range of between about 5000 and 8500. A preferred weight average is between about 6000 and 7000 as this provides a polish with good viscosity and resistance to freezing.

The wetting agent of the invention generally is a combination of an alcohol and a glycol. A suitable alcohol is a butyl alcohol. A suitable glycol is ethylene glycol. The preferred wetting agent is dipropylene glycol-n-butyl ether (“DPNB”) at a ratio of one-part trimethyl pentanediol alcohol (Texanol) with 2-parts DPNB because of solubility. The Texanol and DPNB blend provides a lipophilic and hydrophilic balance that is more compatible with the polymer blend.

The polish of the invention may be applied in any suitable way. It may be applied by pump sprayer or low-pressure airless sprayer. The material may be allowed to stand with three minutes and agitated with a soft nylon bristle brush prior to being wiped off by a soft cloth until the desired sheen is obtained. The material also may be applied with a mop, sponge or wiped on with the cloth. The material normally will be polished with a soft cloth or polishing machine to obtain a sheen.

The polish application rate should be between seventy-five (75) and one hundred (100) square feet per gallon on wood surfaces, and 50% higher on metals, fiberglass, bumpers, painted surfaces, tires, dashboard, rims, and car surfaces. When used on anodized aluminum surfaces, allow the invention polish to penetrate and lift the oxidation film so it becomes soluble and is then easily removable with a soft cloth. This may take as long as five (5) minutes. Reapply material so that a new protective polymeric film remains on the aluminum to give it a new smooth finish and shines bright. Reapplying a second coat is never discouraged as it will only add to the film that is protecting the surface and give the finished surface a smoothness never before achieved with waxes or solvents.

The polish of the invention has a viscosity generally in the range of 10-40 mPa for floor coatings. The viscosity for other surfaces usually is between 10 and 25 mPa.

Additional minor amounts of other ingredients can be included to improve the performance of the polish of the present invention. These materials would include UV absorbers, surfactants, colorants, scents, fillers, and defoamers commonly found in polishes.

### Example 1

Acrylic polymer emulsion comprising Roplex CS-4000 acrylic emulsion in an amount of 4 kilograms which is blended with 1 kilogram of vinyl acrylic copolymer emulsion.

The Roplex CS-4000 comprises about 2 kilograms of water and 2 kilograms of a vinyl acrylic copolymer comprising 50% acrylic polymer and 50% vinyl acrylic polymer. This emulsion was then blended with 0.12 kilograms of DPNB, and 0.25 kilograms of Texanol, a trimethyl pentanediol alcohol. This formulation is suitable for application to a hard surface that requires a high polish. The rate of application is 100 to 150 square feet per gallon of the polish. This material was applied at the rate of 100 and 150 square feet per gallon to an inlay kitchen floor. After polishing a hard long-lasting protective layer was present.

1. A polish comprising acrylic polymers and a wetting agent comprising a high-weight alcohol mixed with a glycol-n-butyl ether.

2. The polish of claim 1, wherein the acrylic polymers comprise a blend of an acrylic emulsion and a vinyl acrylic copolymer in an emulsion.

3. The polish of claim 2, wherein the glycol-n-butyl ether comprises dipropylene glycol-n-butyl ether.

4. The polish of claim 4, wherein the high weight alcohol comprises 2,2,4 Trimethyl01, 3 pentanediol monoisobutyrate.

5. The polish of claim 1, wherein the viscosity is between 10 and 40 mPa.

6. The polish of claim 1, wherein the polish coats between 200 and 500 feet per gallon.

7. The polish of claim 1 further comprising propylene glycol or polyethylene glycol.
